(19) United States
(12) Patent Application Publication
(10) Pub. No.: US 2021/0402636 A1
(43) Pub. Date: Dec. 30, 2021

(54) GUIDE SYSTEMS FOR MARKING WORKPIECES

(71) Applicant: Raymond Joe Mus, Portland, OR (US)

(72) Inventor: Raymond Joe Mus, Portland, OR (US)

(21) Appl. No.: 17/363,800

(22) Filed: Jun. 30, 2021

Related U.S. Application Data
(60) Provisional application No. 63/046,086, filed on Jun. 30, 2020.

(51) Int. Cl. B26D 7/01; B23D 33/12

(52) U.S. Cl. CPC B26D 7/01; B23D 33/12

(57) ABSTRACT

Guide systems to facilitate marking a workpiece. The guide systems include a platform and a set of guides. The platform flanks the workpiece on two sides and includes a first member and a second member. The second member is spaced from the first member. The set of guides includes a first guide and a second guide. The first guide has a first profile edge. The second guide is spaced from the first guide and has a second profile edge. A tool may be pressed against the first profile edge or the second profile edge to form a mark on the workpiece corresponding to the first profile edge or the second profile edge, respectively. In some examples, the guide system includes adjustable guides. In other examples, guides are fixed.

### CROSS REFERENCE TO RELATED APPLICATIONS

This application claims priority to copending U.S. Application, Ser. No. 63/046,086, filed on Jun. 30 2020, which is hereby incorporated by reference for all purposes.

### BACKGROUND

The present disclosure relates generally to guide systems. In particular, guide systems for marking workpieces are described.

Marking workpieces is a common technique to more accurately and effectively process the workpiece further. For example, one may score a cut line to a sheet of glass or mark a circle to be cut from a piece of wood. Workpieces are commonly marked with a pen, a pencil, a piece of chalk, a knife, or a scoring tool.

Accurately marking workpieces is a challenge. It can be difficult to mark a desired edge or profile shape in the right location and without deviating from the intended marking path. Existing tools or systems for guiding a marking tool, such as a straight edge or a T-square, can assist with marking a workpiece, but are not well suited for many applications. Conventional guide tools or systems generally fall into two categories: simple tools and complex systems. Both categories of conventional guide tools and systems suffer a number of drawbacks.

For example, conventional simple guide tools typically provide only one or two guides and require the user to manually move something to mark a workpiece. Some conventional tools entail moving the guide or and others entail moving the workpiece. Either way, moving the guide or workpiece requires multiple successive measurements and reduces accuracy. Having to make multiple measurements is slow and prone to errors, which costs time and wastes material due to inaccurate marks.

Further, existing simple guides make it quite difficult to make truly perpendicular or parallel marks if one or more edges of the materials is not straight or square. Certain types of workpiece materials, such as specialty lumber and colored sheet glass, often rare edges that are not straight or square.

Another limitation of conventional simple guides is that it is difficult to make accurate angled marks on a workpiece with them. The difficulty of marking angled profiles on a workpiece means that it takes a long time to mark an angled profile. Further, the difficulty often leads to wasting workpieces because inaccurately marked angled profiles cause the workpiece to be processed inaccurately and discarded.

Conventional complex guide systems, such as electronically automated machines, are often expensive complex, and require a large amount of space. The expense, complexity, and space required for existing complex guide systems renders them ill-suited to individuals and small businesses.

Thus, there exists a need for guide systems that improve upon and advance the design of known guide systems. Examples of new and useful guide systems relevant to the needs existing in the field are discussed below.

### SUMMARY

The present disclosure is directed to guide systems configured to facilitate marking a workpiece. The guide systems include a platform and a set or guides. The platform flanks the workpiece on two sides and includes a first member and a second member. The second member is spaced from the first member. The set of guides includes a first guide and a second guide. The first guide has a first profile edge. The second guide is spaced from the first guide and has a second profile edge. A tool may be pressed against the first profile edge or the second profile edge to form a mark on the workpiece corresponding to the first profile edge or the second profile edge, respectively. In some examples, the guide system includes adjustable guides. In other examples, the guides are fixed.

### BRIEF DESCRIPTION OF THE DRAWINGS

FIG. 1 is a perspective view of a first embodiment of a guide system over a workpiece.

FIG. 2 is a top plan view of the guide system shown in FIG. 1.

FIG. 3 is a left side end view of the guide system shown in FIG. 1 over a workpiece.

FIG. 4 is a perspective view of a second embodiment of a guide system.

FIG. 5 is a left side end view of the guide system shown in FIG. 4.

FIG. 6 is a perspective view of the guide system shown in FIG. 4 with a circle marking guide installed.

FIG. 7 is a close up perspective view of the circle marking guide shown in FIG. 6.

FIG. 8 is a perspective view of the guide system shown in FIG. 4 with two different French curve guide members installed.

FIG. 9 is a top plan view of the guide system shown in FIG. 4 depicting an upper member longitudinally offset relative to a lower member.

### DETAILED DESCRIPTION

The disclosed guide systems will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various guide systems are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, hat max have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

### Guide Systems for Marking Workpieces

With reference to the figures, guide systems for workpieces will now be described. The guide systems discussed herein function to facilitate marking a workpiece with a tool by providing a guide for the tool.

In this document, marking means drawing on, scoring, or cutting a workpiece. Often the guide systems will be used to score workpieces. However, the guide systems are also regularly used to draw lines or profiles on a workpiece or to cut through the workpiece entirely.

The reader will appreciate from the figures and description below that the presently disclosed guide systems address many of the shortcomings of conventional guide systems. For example, the guide systems described below do not require the user to manually move something multiple times to mark a workpiece in multiple locations. By avoiding the need for multiple successive measurements as is required in conventional guide systems, the accuracy of the marks is increased with the guide systems described herein. The guide systems below also increase the speed in which a workpiece can be marked and reduces the error rate of marks, which saves time and reduces wasted material.

Further, the novel guide systems described below enable readily making truly perpendicular or parallel marks on workpieces with edges that are not straight or square. Thus, the guide systems described herein are especially well suited for specialty lumber and colored sheet glass, which often have edges that are not straight or square.

Unlike conventional simple guides, the guide systems described in this document make it easy to accurately mark angled lines on a workpieces. The guide systems below allow angled marks to be made significantly faster and more accurately than with conventional guides. The guide systems herein enabling more accurate angled marks reduces wasted workpieces resulting from inaccurate marks.

The guide systems discussed herein provide numerous marking capability improvements without being as complex as existing complex guide systems, such as electronically automated machines. As a result, the guide systems discussed below avoid the expense and extensive space requirements of conventional complex guide systems. The reduced expense, complexity, and space required for the guide systems discussed herein makes them well-suited for individuals and small businesses.

### Contextual Details

Ancillary features relevant to the guide systems described herein will first be described to provide context and to aid the discussion of the guide systems.

### Workpiece

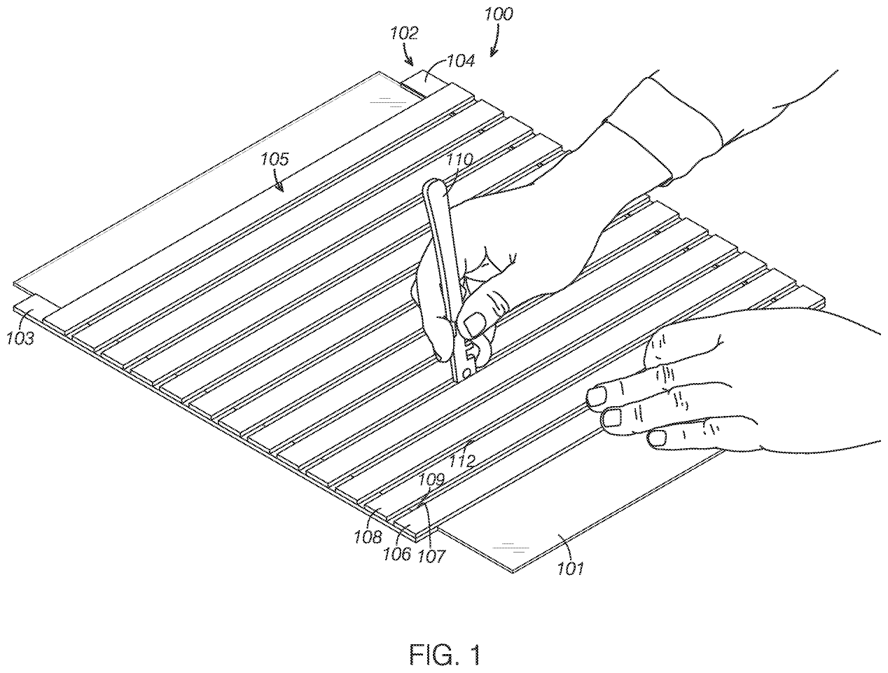

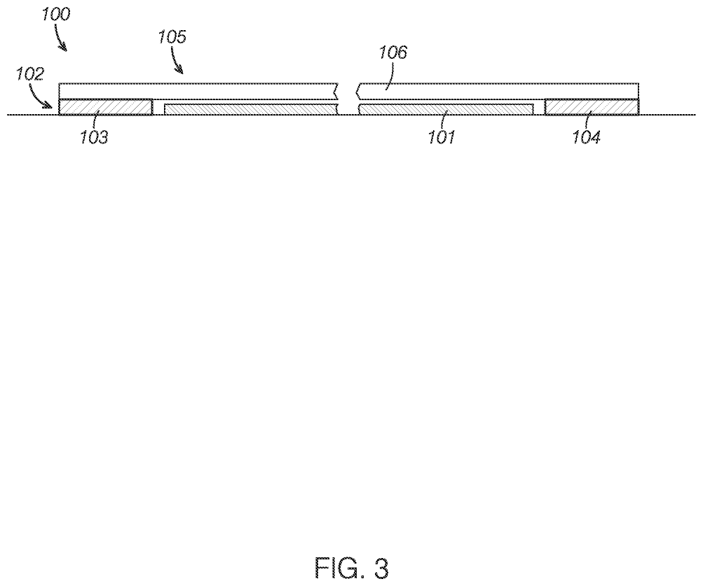

A variety of workpieces may be marked with the guide systems described below, including workpiece 101 depicted in FIGS. 1 and 3. The workpiece may be any currently known or later developed type of workpiece, such as glass, wood, plastic, or metal sheets. The reader will appreciate that a variety of workpiece types exist and could be used in place of the workpiece shown in the figures. In addition to the types of workpiece existing currently, it is contemplated that the guide systems described herein could be used with new types of workpieces developed in the future.

The size and shape of the workpiece may be varied as needed for a given application. In some examples, the workpiece is larger relative to the other components than depicted in the figures. In other examples, the workpiece is smaller relative to the other components than depicted in the figures. Further, the reader should understand that the workpiece and the other components may all be larger or smaller than described herein while maintaining their relative proportions.

### Tool

Tool 110 functions to mark a workpiece. Marking the workpiece may include drawing a line, curve, or other profile on the workpiece with a pen, pencil, or other marking tool. Marking the workpiece may additionally or alternatively include scoring the workpiece with a scoring tool or knife.

The size and shape of the tool may be varied as needed for a given application. In some examples, the tool is larger relative to the other components than depicted in the figures. In other examples, the tool is smaller relative to the other components than depicted in the figures. Further, the reader should understand that the tool and the other components may all be larger or smaller than described herein while maintaining their relative proportions.

The number of tools used with the guide system may be selected to meet the needs of given application. The reader should appreciate that the number of tools may be different in other examples than is shown in the figures. For instance, some guide system examples may be used with additional or fewer tools than described in the present example.

The tool may be any currently known or later developed type of tool, such as a pen, pencil, or other marking tool; or a knife or other scoring tool. The reader will appreciate that a variety of tool types exist and could be used in place of the tool shown in the figures. In addition to the types of tools existing currently, it is contemplated that the guide systems described herein could be used with new types of tools developed in the future.

### Guide System Embodiment One

With reference to FIGS. 1-3, a guide system 100 will now be described as a first example of a guide system. As shown in FIGS. 1-3, guide system 100 functions to facilitate marking a workpiece 101 with a tool, such as tool 110.

In the example shown in FIGS. 1-5, guide system 100 includes a platform 102 and a set of guides 105. In other examples, the guide system includes fewer components than depicted in the figures. In certain examples, the guide system includes additional or alternative components than depicted in the figures.

The overall size and shape of the guide system may be varied as needed for a given application. In some examples, the guide system is larger relative to the tool and workpiece than depicted in the figures. In other examples, the guide system is smaller relative to the tool and workpiece than depicted in the figures. Further, the reader should understand that the guide system and the tool and workpiece may all be larger or smaller than described herein while maintaining their relative proportions.

### Platform

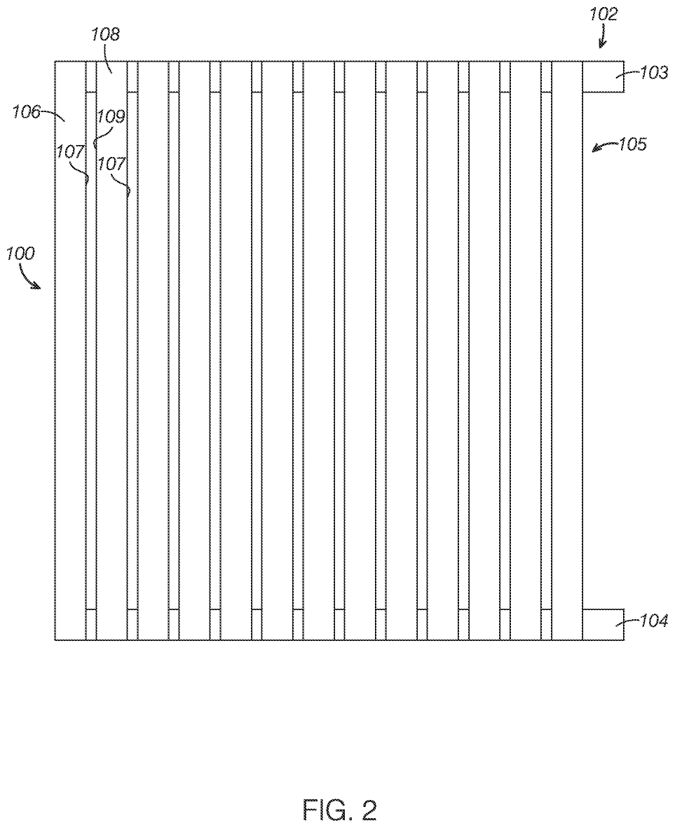

Platform 102 functions to support set of guides 105. The reader can see in FIGS. 1 and 2 that platform 102 includes a first member 103 and a second member 104.

As shown in FIGS. 1-3, platform 102 flanks workpiece 101 on two sides. In the particular example shown in FIGS. 1-3, platform 102 flanks workpiece 101 on lateral sides of workpiece 101 so that the length of workpiece 101 is disposed under set of guides 105. However, the platform may be positioned to flank longitudinal sides of the workpiece instead.

The size and shape of the platform may be varied as needed o a given application. In some examples, the platform is larger relative to the other components than depicted in the figures. In other examples, the platform is smaller relative to the other components than depicted in the figures. Further, the reader should understand that the platform and the other components may all be larger or smaller than described herein while maintaining their relative proportions.

In the present example, the platform is composed of metal. However, the platform may be composed of any currently known or later developed material suitable for the applications described herein for which it is used. Suitable materials include metals, polymers, ceramics, wood, and composite materials.

### Members

The members function to support set of guides 105 from opposite sides of workpiece 101. The reader can see in FIGS. 1 and 2 that second member 104 is spaced from first member 103. In the orientation depicted in FIGS. 1-3, first member 103 is disposed on a first lateral side of workpiece 101 and second member 104 is disposed on a second lateral side of workpiece 101 on an opposite side of workpiece 101 than the first lateral side.

The size and shape of the members may be varied as needed for a given application. In some examples, the members are larger relative to the other components than depicted in the figures. In other examples, the members are smaller relative to the other components than depicted in the figures. Further, the reader should understand that the members and the other components may all be larger or smaller than described herein while maintaining their relative proportions.

In the present example, the members are composed of metal. However, the members may be composed of any currently known or later developed material suitable for the applications described herein for which they are used. Suitable materials include metals, polymers, ceramics, wood, and composite materials.

### Guides

Set of guides 105 serve to facilitate marking workpiece 101 with tool 110. In particular, set of guides 105 enable marking workpiece with tool 110 at specific locations and with selected profiles. Set of guides 105 allow for marking workpiece 101 with tool 110 in multiple locations quickly, accurately, and efficiently.

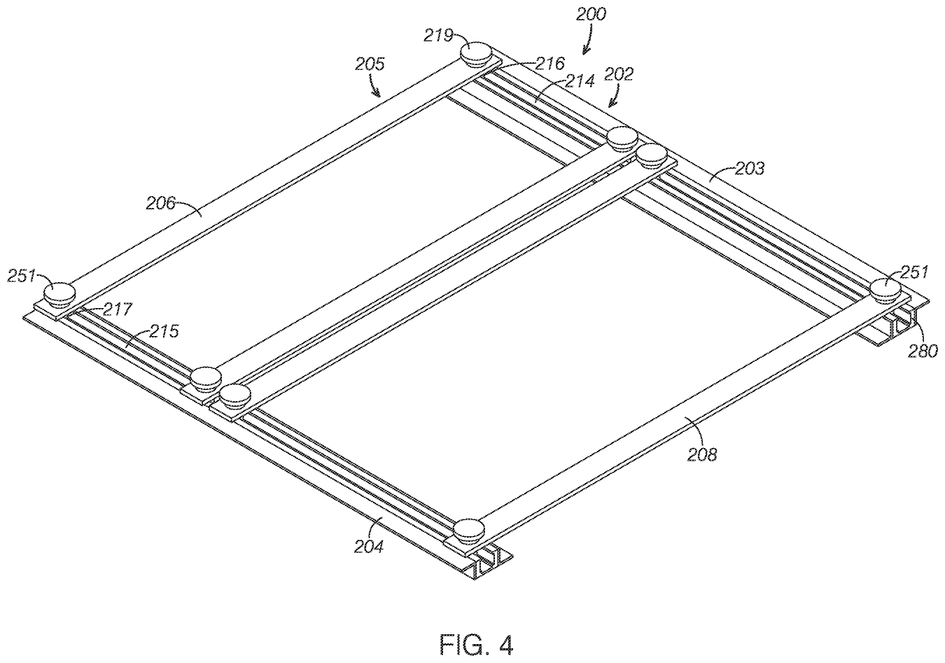

The reader can see in FIGS. 1-3 that set of guides 105 are fixed to platform 102. However, in other examples, such as shown in FIGS. 4-9 with reference to set of guides 205 discussed below, the set of guides may be movably supported by the platform rather than fixed to the platform. FIGS. 4-9 depict and example where the set of guides are movably supported on the platform via posts moving through slots formed in the members of the platform. Selective magnetic coupling of the set of guides to the platform with a relatively high friction interface between the set of guides and the platform is another example of the set of guides being movably supported on the platform.

In the example shown in FIGS. 1-3 set of guides 105 includes a first guide 106 and a second guide 108 along with a plurality of additional guides. The number of guides in the guide system may be selected to meet the needs of a given application. The reader should appreciate that the number of guides may be different in other examples than is shown in the figures. For instance, some guide system examples include additional or fewer guides than described in the present example.

With reference to FIGS. 1 and 2, second guide 108 is spaced from first guide 106. Second guide 108 is spaced from first guide 106 by a fixed, known distance to aid marking workpiece 101 at specific locations. The other plurality of guides in set of guides 105 are also spaced out at fixed, known distances to aid marking workpiece 101 at specific locations quickly, accurately, and efficiently.

As depicted in FIGS. 1 and 2, first guide 106 has a first profile edge 107 and second guide 108 has second profile edge 109. As shown in FIGS. 1 and 2, second guide 108 has a third profile edge 112 opposite second profile edge 109. As depicted in FIGS. 1 and 2, tool 110 may be pressed against first profile edge 107, second profile edge 109, or third profile edge 112 to form a mark 111 on workpiece 101 corresponding to first profile edge 107, second profile edge 109, or third profile edge 112, respectively.

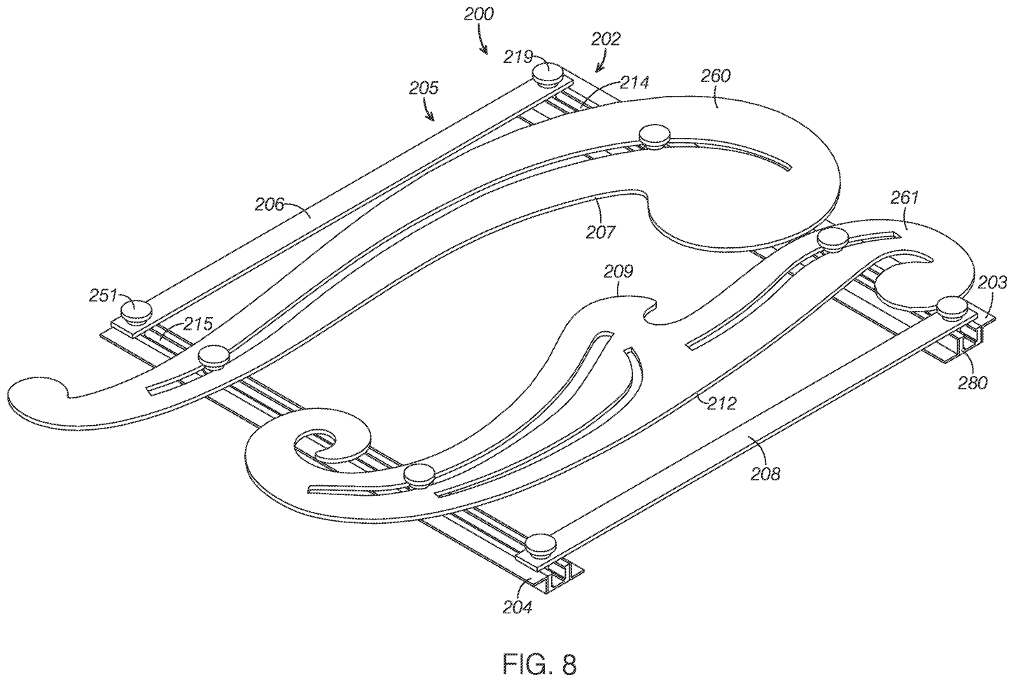

In the example shown in FIGS. 1-3, first profile edge 107, second profile edge 109, and third profile edge 112 each define a straight line. However, in other examples the different profile edges define different profiles. For example, as shown in FIG. 8, the profile edges may be curved, such as defining a French curve. Other potential profile edge shapes beyond straight and curved include faceted, angled, and irregular profile edge shapes.

The shape of the guides may be adapted to be different than the specific examples shown the figures to suit a given application. For example, one or more of the guides may include a face having the shape of a regular or irregular polygon, such as a circle, oval, triangle, square, rectangle pentagon, and the like. Additionally or alternatively, one or more of the guides may include a face having an irregular shape. In three dimensions, the shape of the guides may be a sphere, a pyramid, a cone, a cube, and variations thereof, such as a hemisphere or a frustoconical shape.

The size of the guides may be varied as needed for a given application. In some examples, the guides are larger relative to the other components than depicted in the figures. In other examples, the guides are smaller relative to the other components than depicted in the figures. Further, the reader should understand that the guides and the other components may all be larger or smaller than described herein while maintaining their relative proportions.

In the present example, the guides are composed of metal. However, the guides may be composed of any currently known or later developed material suitable for the applications described herein for which they are used. Suitable materials include metals, polymers, ceramics, wood, and composite materials.

### Additional Embodiments

With reference to the figures not yet discussed in detail, the discussion will now focus on additional guide system embodiments. The additional embodiments include many similar or identical features to guide system 100. Thus, for the sake of brevity, each feature of the additional embodiments below will not be redundantly explained. Rather, key distinctions between the additional embodiments and guide system 100 will be described in detail and the reader should reference the discussion above for features substantially similar between the different guide system examples.

### Guide System Embodiment Two

Turning attention to FIGS. 4-9, a guide system 200 will now be described as a second example of a guide system. As can be seen in FIGS. 4-9, guide system 200 includes a platform 202, and a set of guides 205. In other examples, the guide system includes fewer components than depicted in the figures. In certain examples, the guide system includes additional or alternative components than depicted in the figures.

### Platform

Whereas platform 102 is configured to fixedly support set of guides 105, platform 202 is configured to movably support set of guides 205. Platform 202 includes slots cooperating with posts included on the guides to movably support set of guides 205.

Platform 202 includes a first member 203 and a second member 204 disposed on opposite sides of a workpiece 201. In FIGS. 4-6 and 8, first member 203 is disposed directly above second member 204 on opposite sides of the workpiece 201. Expressed another way, in FIGS. 4-6 and 8, first member 203 is longitudinally aligned with second member 204.

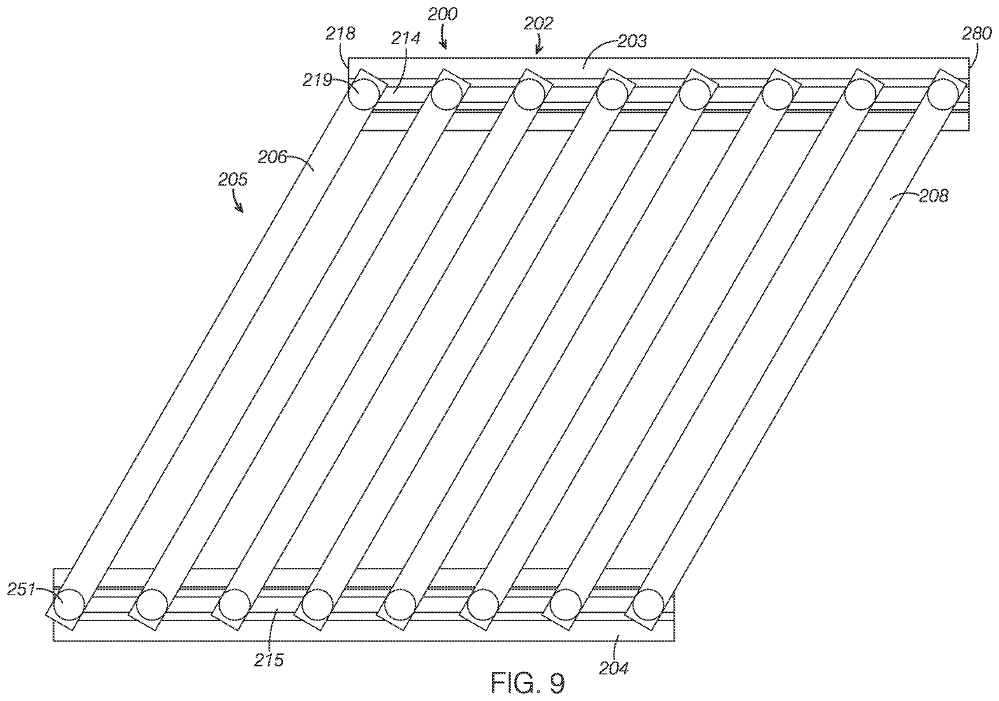

In contrast, the reader can see in FIG. 9 that first member 203 is longitudinally offset from second member 204 on opposite sides of workpiece 201. Selectively longitudinally offsetting first member 203 from second member 204 causes set of guides 205 to be oriented at an angle relative to the longitudinal direction of platform 202. In the example depicted in FIG. 9, the longitudinal direction of platform 202 corresponds to the length of a workpiece disposed under set of guides 205. Thus, selectively longitudinally offsetting first member 203 from second member 204 causes set of guides 205 to be oriented at an angle relative to the length of the workpiece. In this manner, guide system 200 can be used to make angled marks on the workpiece effectively and accurately.

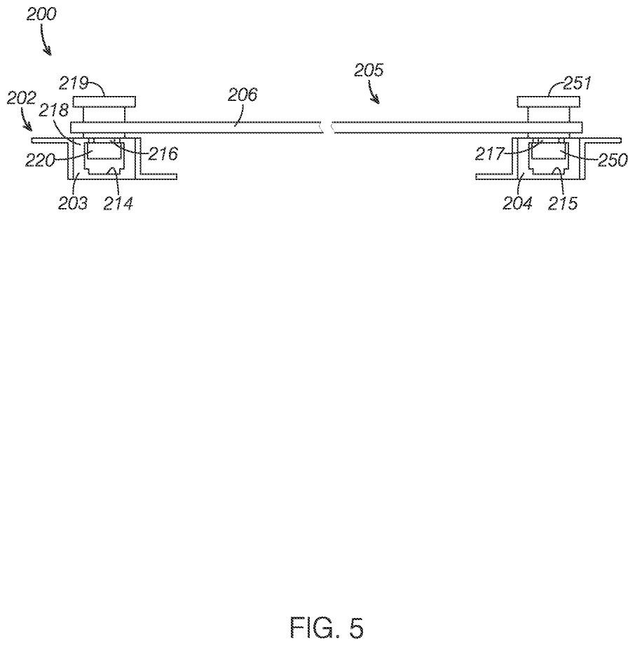

As shown in FIGS. 4 and 5, first member 203 defines a first slot 214. With reference to FIGS. 4 and 5, second member 204 defines a second slot 215.

### Slots

The slots function to receive posts of the guides and to define a longitudinal path about which the posts may travel. As shown in FIGS. 4 and 5, first slot 214 is complementarily configured with first post 216 to allow first post 216 to slide within first slot 214 along the length of first slot 214. The reader can see in FIGS. 4 and 5 that second slot 215 is complementarily configured with second post 217 to allow second post 217 to slide within second slot 215 along the length of second slot 215.

The slots also function to bound the lateral travel of the posts. As depicted in FIGS. 4 and 5, first slot 214 is complementarily is configured with first post 216 to restrict first post 216 from moving laterally within first slot 214 transverse to the length of first slot 214. With reference to FIGS. 4 and 5, second slot 215 is complementarily is configured with second post 217 to restrict second post 217 from moving laterally within second slot 215 transverse to the length of second slot 215.

As shown in FIG. 5, first slot 214 is open on a first end 218 to allow first post 216 to selectively enter and exit first slot 214 from first end 218. As shown in FIGS. 4 and 5, first slot 214 is also open on a second end 280 opposite first end 218. Second slot 215 is also open on its ends to allow posts on the guides to selectively enter and exit second slot 215.

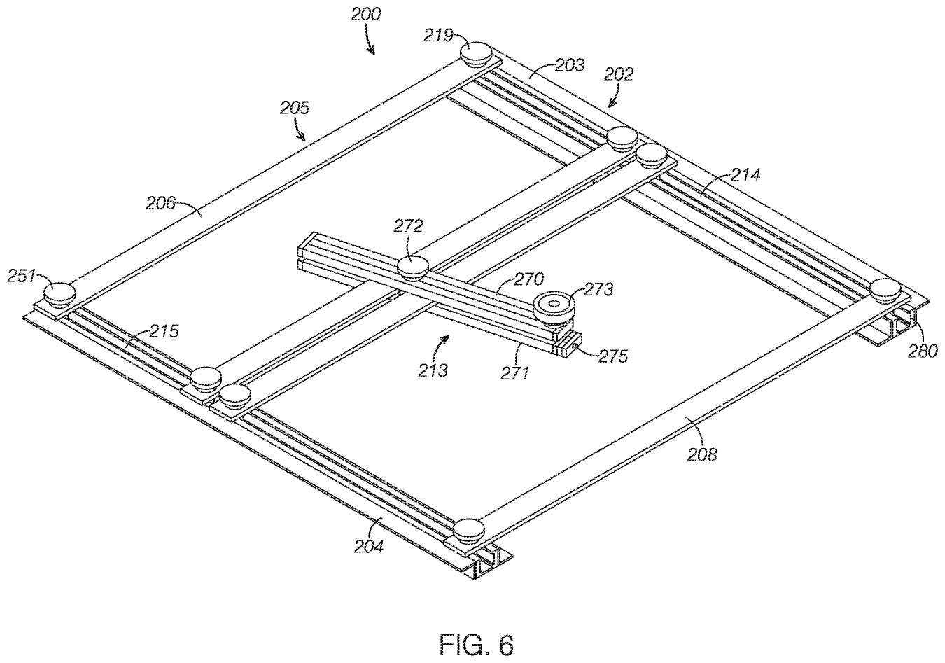

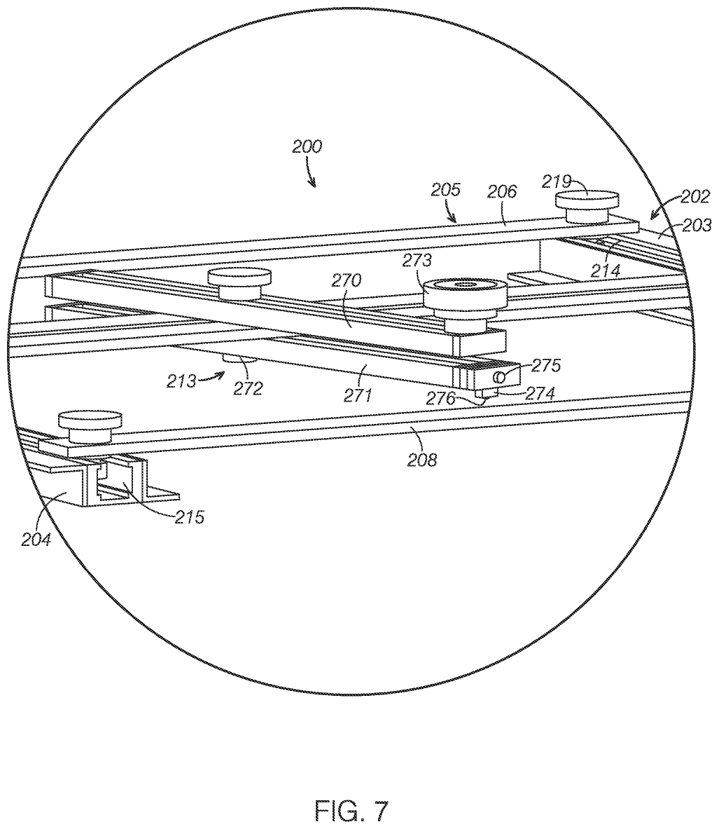

The open ends of the slots enable different guides to be selectively added and removed from guide system 200 to facilitate marking workpiece 205 with different profiles. For example, a user may selectively remove a guide with a straight profile edge and add a guide with a curved profile edge to mark the workpiece with a curved profile. Examples of different guides that may be added to guide system 200 include a circle marking guide 213 depicted in FIGS. 6 and 7, a first French curve guide 260 depicted in FIG. 8, and a second French curve guide 261 depicted in FIG. 8. Many other types of guides may be selectively added and removed from the guide system as desired.

The size and shape of the slots may be varied as needed for a given application. In some examples, the slots are larger relative to the other components than depicted in the figures. In other examples, the slots are smaller relative to the other components than depicted in the figures. Further, the reader should understand that the slots and the other components may all be larger or smaller than described herein while maintaining their relative proportions.

### Guides

Unlike set of guides 105 that are fixed to platform 102, the reader can see in FIGS. 4 and 5 that set of guides 205 are movably supported on platform 202. As shown in FIGS. 4 and 5 and discussed above, set of guides 205 are configured to be selectively separated from platform 202.

As depicted in FIGS. 4 and 5, a first guide 206 includes a first post 216 and a second post 217 configured to reside and move in first slot 214 and second slot 215, respectively. In the example shown in FIGS. 4 and 5, first post 216 and second post 217 are threaded. As depicted in FIGS. 4 and 5, first post 216 extends into first slot 214 and second post 217 extends into second slot 215.

As shown in FIG. 5, first post 216 includes a head 220 within first slot 214. Second post 217 includes a head 250 within second slot 215. Head 220 and head 250 are configured to selectively engage first slot 214 and second slot 215, respectively, to selectively restrict first guide 206 from moving relative to platform 202.

With reference to FIGS. 4 and 5, first guide 206 includes a knob 219 attached to first post 216 to assist with selectively moving first guide 206. Knob 219 also assists to selectively restrict first guide 206 from moving. The reader can see in FIGS. 4 and 5 that knob 219 raises first post 216 and compresses head 220 against first slot 214 to restrict first guide 206 member from moving. In the example shown in FIGS. 4 and 5, first guide 206 also includes a second knob 251 configured and functioning the same as first knob 219.

The knobs may be any currently known or later developed type of knob. The reader will appreciate that a variety of knob types exist and could be used in place of the knobs shown in the figures. In addition to the types of knobs existing currently, it is contemplated that the guide systems described herein could incorporate new types of knobs developed in the future.

The size and shape of the knobs may be varied as needed for a given application. In some examples, the knobs are larger relative to the other components than depicted in the figures. In other examples, the knobs are smaller relative to the other components than depicted in the figures. Further, the reader should understand that the knobs and the other components may all be larger or smaller than described herein while maintaining their relative proportions.

### Guide Types and Profile Edges

In the example shown in FIGS. 4-9, a variety of guides within set of guides 205 are depicted. The guides depicted in FIGS. 4-9 include a first guide 206, a second guide 208, a circle marking guide 213, a first French curve guide 260, and a second French curve guide 261. Circle marking guide 213 is depicted in FIGS. 6 and 7. First French curve guide 260 and second French curve guide 261 are depicted in FIG. 8.

With reference to FIG. 8, first French curve guide 260 includes a first profile edge 207. Second French curve guide 261 includes a second profile edge 209 and a third profile edge 212. As depicted in FIG. 8, first profile edge 207, second profile edge 209, and third profile edge 212 are all curved. However, with reference to FIG. 8, first profile edge 207 defines a different profile than second profile edge 209. The reader can see in FIG. 8 that third profile edge 212 defines a different profile than second profile edge 209 as well.

### Circle Marking Guide

Circle marking guide 113 functions to mark a circle on a workpiece, As depicted in FIGS. 6 and 7, circle marking guide 213 is supported on platform 202 and extends between first member 203 and second member 204 over where a workpiece would be positioned under set of guides 205.

As shown in FIGS. 6 and 7 circle marking guide 113 includes an upper arm 270, a lower arm 271, a coupling member 272, a handle 273, a scoring tool 274, and an adjustment mechanism 275. However, the circle marking guide may be any currently known or later developed type of circle marking guide. The reader will appreciate that a variety of circle marking guide types exist and could be used in place of the circle marking guide shown in the figures. In addition to the types of circle marking guides existing currently, it is contemplated that the guide systems described herein could incorporate new types of circle marking guides developed in the future.

As shown in FIGS. 6 and 7, coupling member 272 couples upper arm 270 to lower arm 271 in a position where upper arm 270 overlies lower arm 271. Coupling meaner 272 also couples circle marking guide 113 to a guide extending between first member 203 and second member 204. Coupling member 272 also serves as a pivot about which upper arm 270 and lower arm 271 rotate. Adjusting the position where coupling member 272 is disposed along the length of upper arm 270 and lower arm 271 establishes the radius of the circle marked by circle marking guide 213.

As shown in FIGS. 6 and 7, handle 273 mounts to upper arm 270 distal coupling member 272 and overlying scoring tool 274. Handle 273 is configured to rotate to make it easier to hold when rotating upper arm 270 and lower arm 271 about coupling member 272. The handle may be any currently known or later developed type of handle and may be any suitable size and shape.

With reference to FIG. 7, the reader can see that scoring tool 274 is mounted to lower arm 271 proximate an end of lower arm 271 distal coupling member 272. Scoring tool 274 is configured to score a workpiece when pressed against and moved over the workpiece. In the example shown in FIGS. 6 and 7, scoring tool 274 includes a blade 276 projecting towards where a workpiece would be positioned under set of guides 205. The scoring tool may be any currently known or later developed type of scoring tool or cutting blade and may be any suitable size and shape.

Adjustment mechanism 275 depicted in FIG. 7 functions to raise and lower blade 276 of scoring tool 274. In the example depicted in FIG. 7, adjustment mechanism 275 includes a set screw for adjusting the vertical position of blade 276. However, the adjustment mechanism may be any currently known or later developed type of adjustment mechanism and may be any suitable size and shape.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or different invention and whether they are different, broader, narrower or equal in scope to the original claims, are to be considered within the subject matter of the inventions described herein.

1. A guide system for a workpiece comprising:
a platform flanking the workpiece on two sides and including:
a first member; and
a second member spaced from the first member; and
a set of guides supported on the platform and extending between the first member and the second member over the workpiece, the set of guides including:
a first guide having a first profile edge;
a second guide spaced from the first guide and having a second profile edge;
wherein a user may slide a tool over the workpiece while pressing the tool against the first profile edge or the second profile edge to form a mark on the workpiece corresponding to the first profile edge or the second profile edge, respectively.

2. The guide system of claim 1, wherein the first profile edge defines the same profile as the second profile edge.

3. The guide system of claim 1, wherein the first profile edge defines a different profile than the second profile edge.

4. The guide system of claim 3, wherein:
the first profile edge is straight; and
the second profile edge is curved.

5. The guide system of claim 1, wherein the second guide has a third profile edge opposite the second profile edge.

6. The guide system of claim 5, herein the third profile edge defines a different profile than the second profile edge.

7. The guide system of claim 1, further comprising a circle marking guide supported on the platform and extending between the first member and the second member over the workpiece.

8. The guide system of claim 1, wherein the set of guides are fixed to the platform.

9. The guide system of claim 1, wherein the set of guides are configured to be selectively separated from the platform.

10. The guide system of claim 1, wherein the set of guides are movably supported on the platform.

11. The guide system of claim 10, wherein:
the first member defines a first slot:
the second member defines a second slot; and
the first guide includes:
a first post extending into the first slot; and
a second post extending into the second slot.

12. The guide system of claim 11, wherein the first slot is complementarily configured with the first post to allow the first post to slide within the first slot along the length of the first slot.

13. The guide system of claim 12, wherein the second slot is complementarily configured with the second post to allow the second post to slide within the second slot along the length of the second slot.

14. The guide system of claim 13, wherein the first slot is complementarily configured with the first post to restrict the first post from moving laterally within the first slot transverse to the length of the first slot.

15. The guide system of claim 14, wherein the second slot is complementarily configured with the second post to restrict the second post from moving laterally the second slot transverse to the length of the second slot.

16. The guide system of claim 11, wherein the first slot is open on a first end to allow the first post to selectively enter and exit the first slot from the first end.

17. The guide system of claim 11, wherein the first guide includes a knob attached to the first post to assist with moving the first guide.

18. The guide system of claim 17, wherein the knob is configured to selectively restrict the first guide from moving.

19. The guide system of claim 18, wherein:
the first post is threaded;
the first post includes a head within the first slot; and
selectively rotating the knob raises the first post and compresses the head against the first slot to restrict the first guide from moving.

20. The guide system of claim 1, wherein the first member is longitudinally offset from the second member on opposite sides of the workpiece.
